(19) United States
(12) Patent Application Publication
(10) Pub. No.: US 2009/0117312 A1
(43) Pub. Date: May 7, 2009

(54) Method for Equipping a Carpet or a Planar Support with Electronic Components, Apparatus for the Method, and a Carpet or Planar Support Comprising Electronic Components

(76) Inventors: Matthias Hanelt, Coppenbrugge (DE); Stefan Peetz, Hehlen (DE); Christl Lauterbach, Hohenkirchen-Siegertsbrunn (DE)

Correspondence Address: COLLARD & ROE, P.C., 1077 NORTHERN BOULEVARD, ROSLYN, NY, 11576, US

(21) Appl. No.: 11/992,043

(22) PCT Filed: Sep. 21, 2006
(86) PCT No.: PCT/EP2006/066595

§ 371 Date: May 6, 2008

(30) Foreign Application Priority Data
Sep. 23, 2005 (DE) 10 2005 045 549.2

(51) Int. Cl. B65C 1/02; B32B 3/22

(52) U.S. Cl. 428/47; 156/230; 156/238; 156/520

(57) ABSTRACT

The invention relates to a method for equipping a carpet (3) with electronic components (2). In order to create a method which ensures that the electronic components can be applied to the carpet in an efficient and accurately locatable manner, the electronic components (2) that are fixedly joined to a support material are glued to the carpet (3) with the aid of the supports (4).

The invention relates in first instance to a method for equipping a carpet, which has a front side and a rear side, with electronic components.

There is a need to provide carpets or carpeting or also non-woven underlays and underlay foams with electronic components. These components may have information about the carpeting to be cleaned or also serve for orientation or navigation, on the carpeting, of an autonomously operating cleaning appliance, thus a robot.

Manual methods are known for thus equipping a carpet, in which the electronic components are placed individually on the carpeting. This method proves to be very time-consuming and costly.

Carpets of the kind in question have a front side, which equates to the use or visible side after the carpet has been laid. The rear side of the carpet is known as carpet backing and forms the support surface.

In the light of the above-described state of the art, a technical problem for the invention is seen in the provision of a method of the kind in question, which ensures efficient and precisely pinpointable application of the electronic components to the carpet, pinpointable meaning predetermined in respect of the location of application of the components.

This problem is solved first and foremost by the subject matter of claim 1, it being provided that the electronic components, which are fixedly connected to a component carrier material forming a component carrier, are adhered to the carpet by means of the component carrier. Accordingly, the electronic components are not connected directly to the carpet. Rather, they are connected fixedly to a component carrier, thus more preferably incorporated into the material of the component carrier. The component carrier provides the connection to the carpet. The electronic components themselves do not come directly into contact with the adhesive agent, thus in particular not with the adhesive. The carrier material may further be a film or a film sleeve, in which the electronic components are accommodated in a protected manner.

The invention further relates to a method for equipping a planar support, for example floor covering, film or paper, which has a front side and a rear side, with electronic components.

There is also a need for providing planar supports, such as for example non-woven materials, PVC-coatings, coatings of felt or non-woven material, laminate, parquet, textile, films, cardboard materials, paper materials or also stone slabs, with electronic components. These components may have information about the support, thus for example information about size and/or specific weight, material and/or colour.

In order also in this regard to provide a method of the kind in question which ensures efficient and precisely pinpointable application of the electronic components to the carpet, it is proposed that the electronic components, which are fixedly connected to a component carrier material forming a component carrier, are adhered to the planar support by means of the component carrier. Accordingly, the electronic components are not connected directly to the support, such as for example a carpet. Rather, they are connected fixedly to a component carrier, thus more preferably incorporated into the material of the component carrier. The component carrier provides the connection to the support, for example to the laminate element or the cardboard layer. The electronic components themselves do not come directly into contact with the adhesive agent, thus in particular not with the adhesive. The carrier material may further be a film or a film sleeve, in which the electronic components are accommodated in a protected manner.

The subjects of the further claims are explained below both with reference to the subject matter of claim 1 and also in respect of the subject matter of claim 2, but may be also of significance in their independent formulation.

Thus it is further provided that the components are adhered to the rear side of the carpet or planar support, as a result of which the components remain in a protected position after in particular the carpet or another floor covering has been laid. Accordingly, these components are not exposed to mechanical loading, for example by vacuum cleaners or the like. Alternatively, the components may also be located between a first backing and a second backing of the carpet or for example between two layers of a laminate element and accordingly in a position in which they are protected on the upper side and on the lower side. The construction according to the invention offers the possibility of providing a multiplicity of components arranged one after the other on a carrier material, for example a striplike carrier material. Thus also for example a pre-prepared carrier material strip comprising applied or incorporated electronic components may be adhered to the carpet or support, furthermore a desired grid pattern being able to be achieved by predetermined spacing of the electronic components with respect to each other. In particular in the case of the arrangement of carrier strips comprising spaced apart components, there is the further possibility of connecting the components to conductors laid on or in the carrier material. The components may also be separated before the adhering by suitable severing of the carrier material, after which the components may be adhered to the carpet in a predetermined grid pattern by means of the component carrier. The severing of the component carrier is preferably carried out between two carrier holding stations, the carrier holding stations being part of a device for application of the electronic components and serving in first instance for feed and transfer of the component carrier comprising the electronic components to the carpet or the planar support. In this regard, it is further proposed that holding of the component on a carrier holding station is effected by vacuum. For further transport or transport away of the component or the component carrier accommodating the component, the vacuum action is specifically interrupted. In advantageous manner, fixing of the electronic component or the associated component carrier on the holding station is thereby achieved, without means acting mechanically on the component carrier or the components. The separated component is applied to the carpet or the planar support by means of a movable holding part, which movable holding part in a further preferred construction acts likewise by vacuum on the component or component carrier to be transported. This transfer is also possible in the case of striplike or planar component carriers having a multiplicity of electronic components. The movable holding part takes the component to be applied over from a carrier holding station acted on by vacuum. For adhering the electronic components or the component carrier for these, the carpet or the planar support may be provided with an adhesive layer before the components are applied, thus for example by spraying or spreading an adhesive or by double-sided adhesive material across the width of the carrier material. Alternatively, the components or the corresponding component carrier for the components may have a self-adhesive layer, which is initially provided with a covering. This covering is removed before the component or the component carrier is applied, so further preferably in the region of one of the carrier holding stations, in particular the holding station which follows the severing station. Furthermore, there is the alternative possibility of providing the component carrier with adhesive on the surface thereof to which components are applied before or after the severing, in so far as a severing action takes place. This provision of adhesive may also be achieved by spraying or spreading or by double-sided adhesive material. The method according to the invention proves especially advantageous when the components—such as also as a rule a carpet product to be equipped—are pre-mounted on a continuous carrier roll. As a result, “continuous” application of the appropriate components, such as for example tags and/or light-emitting diodes, in a preferably freely selectable grid pattern, onto a web product of for example 0.5 to 6 metres width, is achieved.

The invention further relates to apparatus for application of electronic components to a carpet. In order to better configure apparatus of the kind in question such that efficient and precisely pinpointable application of electronic components may be achieved, it is proposed that the components are pre-mounted, applied to a continuous carrier web, and that a separation station is subsequently associated with the carrier web, in order to separate the components. An apparatus is created by means of which the components, which are supplied in a protected manner on or in a continuous carrier web, are applied to the carpet. By means of the separating station, separation of the components or of the components disposed on the carrier web can be achieved, without every component necessarily having thereby to be separated. Rather there is the possibility of separating a series of components from the continuous carrier web, i.e. a strip of carrier web comprising a multiplicity of components applied uniformly or non-uniformly at a pre-defined spacing from one another. This continuous carrier web is preferably pre-mounted on a roller, it being possible further to adapt the width of the carrier web to the width of the carpet to be equipped. Alternatively, several carrier web strips may be applied in parallel across the width of a carpet, an individual unit comprising its own continuous carrier web roller being provided for each component row which is to be placed on the carpet. In this case, the units are synchronized in order to ensure a uniform grid pattern over the entire width of the carpet. The machine parts of the apparatus, which come into contact with electronic components, are arranged to be antistatic.

The invention also relates to apparatus for application of electronic components to a planar support, for example floor covering such as non-woven materials, stone slabs, laminate, parquet or PVC coverings, felt coverings or non-woven coverings, linoleum, LV—coverings, or further for example, film, textile, cardboard or paper. In order to better configure apparatus of the kind in question such that efficient and precisely pinpointable application of electronic components may be achieved, it is proposed that the components are pre-mounted, applied to a continuous carrier web, and that a separation station is subsequently associated with the carrier web, in order to separate the components. An apparatus is created by means of which the components, which are supplied in a protected manner on or in a continuous carrier web, are applied to the planar support. By means of the separating station, separation of the components or the components disposed on the carrier web can be achieved, without every component necessarily having thereby to be separated. Rather there is the possibility of separating a series of components from the continuous carrier web, i.e. a strip of carrier web comprising a multiplicity of components applied uniformly or non-uniformly at a pre-defined spacing from one another. This continuous carrier web is preferably pre-mounted on a roller, it being possible further to adapt the width of the carrier web to the width of the support to be equipped. Alternatively, several carrier web strips may be applied in parallel across the width of a planar support, an individual unit comprising its own continuous carrier web roller being provided for each component row which is to be placed on the support. In this case the units are synchronized in order to ensure a uniform grid pattern over the entire width of the support. The machine parts of the apparatus, which come into contact with electronic components, are arranged to be antistatic.

The subjects of the further claims are explained below both with reference to the subject matter of claim 14 and also in respect of the subject matter of claim 15, but may be also of significance in their independent formulation.

Thus in a development of the subject matter of the invention, it is provided that a handling device is associated with the separating station, the handling device receiving a separated component and applying it to the carpet or the planar support. In a preferred configuration, the separating station consists of two support tables, which are located one after the other in the direction of transport of the carrier web, a cutting station being located between the support tables. The carrier web is, as a result of this configuration, transported over the support tables which are arranged one after the other, while being crossed by the cutting station for separating the components or the component carrier accommodating the components. For this, one support table has a drive roller for the continuous carrier web, which is preferably pre-mounted on a roller. Further, one support table, preferably both support tables, has a vacuum device, by means of which retention on the retaining station of the carrier web or the component carrier separated after the cutting operation is achieved. The handling device is associated with the further support table, i.e. preferably the support table which has no supply roll. Accordingly this further support table carries the separated component after the cutting operation. The handling device transports the separated component or its component carrier from the further support table to the carpet or support by vacuum, for which the vacuum action on the separated component changes from that effected by the support table to action effected by the handling device. The handling device transports the component onto a rear side of the carpet or planar support, which rear side may also be the rear side of a first backing or a second backing. In the case of the location of the components on the first backing, a finishing application of a second backing of a carpet or a second layer, for example of a laminate element, is provided, as a result of which the electronic components which have been applied are brought into a protected position. In order to adhere the electronic components or their component carrier to the carpet or carpet backing or support or support rear side, an application of adhesive to the component carrier is effected on the further support table in the course of the forward transport of the component carrier. This application of adhesive may be effected before separation of the carrier web. Application of adhesive after the cutting operation is also conceivable. For example, the application of adhesive is effected by way of a spray device or a roller device. Alternatively, the component carrier may have a self-adhesive layer with a film covering, the film covering being removed in the region of the further support table. The handling device always transports, to the carpet or planar support, a component carrier capable of being adhered, irrespective of whether a separate adhesive application is carried out or whether the component carrier has a self-adhesive layer. As a further alternative, the equipping of a carpet or support with electronic components or with a carrier web bearing these electronic components may also be effected in the manner of a lamination, thus further in a continuous method, for which both the carrier web having the components and the carpet or a non-woven underlay to be equipped or the planar support are drawn off directly from the respective roll and, after the carrier web is coated with adhesive and immediately before application of the components or carrier web on the rear side, fixing takes place by way of a pressure roller or the like. A possibly desired component grid pattern on the carpet or on the support, further for example on the rear side, may here be achieved by appropriate spacing of the electronic components within or on the carrier web.

As an alternative to the above-described method, application of the components may also be undertaken by means of a conventional labelling machine. For this, the components are applied to a carrier strip, which is coated to be resistant to adhering, for example a silicon strip, and then glued to the carpet by means of the pressure-sensitive adhesive, with the carrier strip being pulled away.

In addition, the invention relates to a carpet, which has a front side and a rear side and is equipped with electronic components. In order to further improve a carpet of the kind in question, it is proposed for the components to be stuck onto the rear side of the carpet by means of a component carrier. As a result, these components are in a protected position after the carpet has been laid. These components are not in particular exposed to a mechanical load from vacuum cleaners or the like. The electronic components may contain information about the carpet, automatic adaptation of the suction parameters of the vacuum cleaner being achievable on the basis of this information.

Finally, the invention relates to a planar support, for example floor covering, film or paper, which has a front side and a rear side and is equipped with electronic components. In order to further improve a support of the kind in question, it is proposed for the components to be stuck onto the rear side of the planar support by means of a component carrier. As a result, the components are in a protected position after the support has been laid. These components are not in particular exposed to mechanical loading, as can for example act on the front side of the support. The electronic components may contain information about the support, automatic adaptation of appliances working on the support being for example achievable on the basis of this information. Also location information or the like can be picked up, this being for example readable by a scanner.

The subjects of the further claims are explained below both with reference to the subject matter of claim 25 and also in respect of the subject matter of claim 26, but may be also of significance in their independent formulation.

A further development proves to be particularly advantageous, to the effect that the components are located between a first and a second backing. As a result of this configuration, the electronic components are covered over in a protected manner both on the upper side and on the lower side. When double-layered felt carriers are used, the electronic components may be placed centrally as seen in a cross-section through the carrier, between the individual felt layers. The components are preferably applied in a grid pattern having a regular longitudinal and transverse spacing, thus for example by cyclical application of separated components or component carriers bearing these components. In this regard, it proves further to be advantageous for the components to be applied by means of a component carrier which is continuous in the longitudinal direction of the carpet or planar support, thus for example in the form of carrier strips having components applied which are spaced apart from one another in a regular manner or in an non-regular manner, according to the grid pattern.

The invention is described in more detail below with reference to the accompanying drawing, which only illustrates embodiments, and in which:

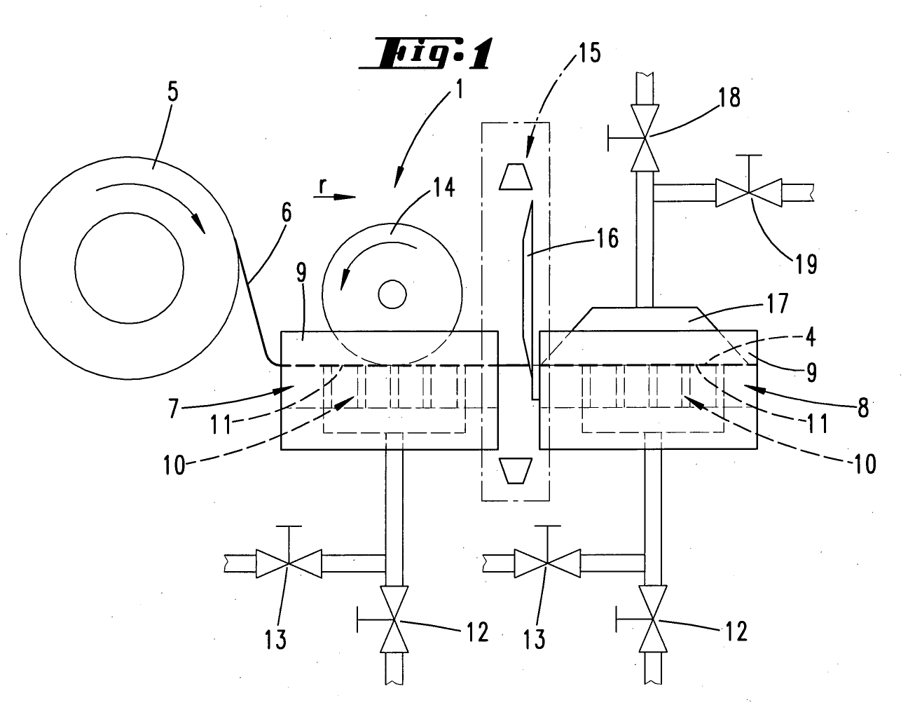

FIG. 1 shows, in schematic illustration, the apparatus in a first embodiment for an intermediate position in which carriers having electronic components are undergoing separation;

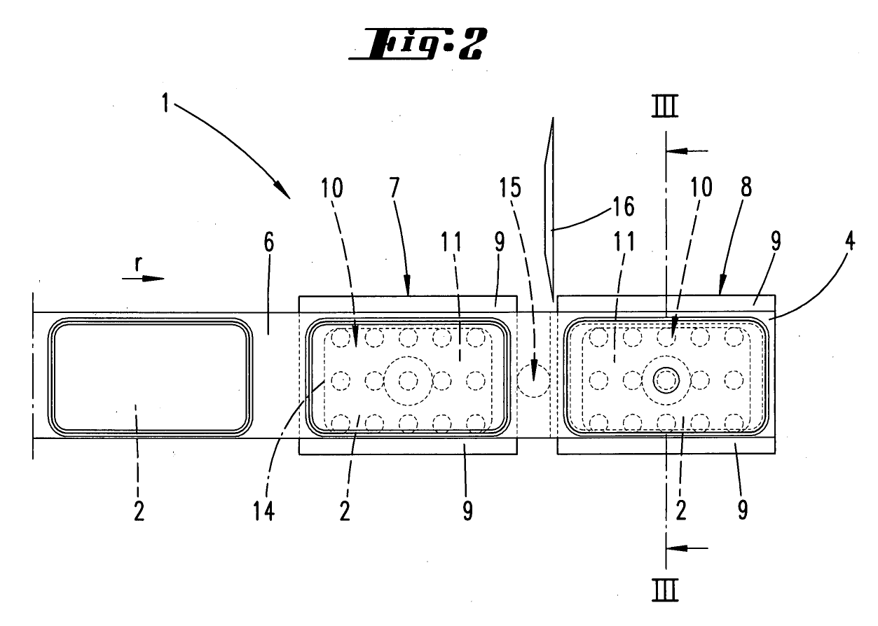

FIG. 2 is a schematic plan view of the illustration in FIG. 1;

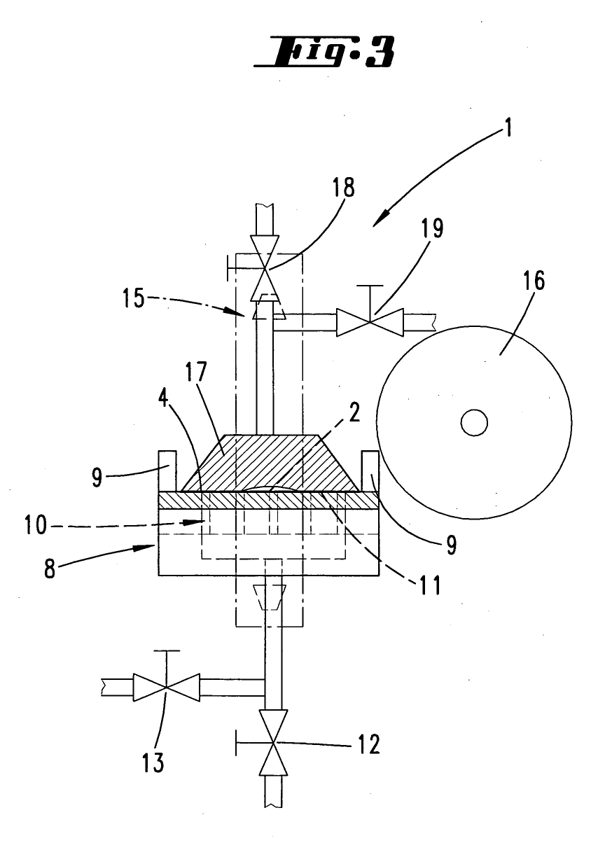

FIG. 3 shows the schematic section on the line III-III in FIG. 2;

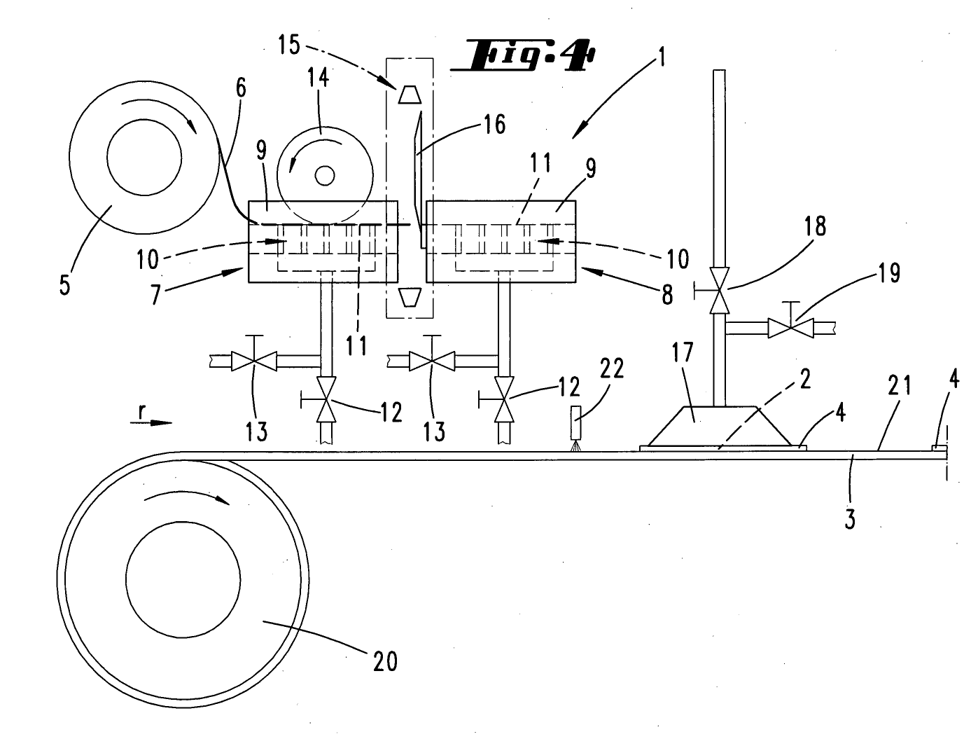

FIG. 4 is a follow-up illustration to FIG. 1 after transfer of the separated carriers onto a carpet backing;

FIG. 5 shows, in exploded perspective illustration, a portion of a carpet with electronic components located between a first backing and a second backing;

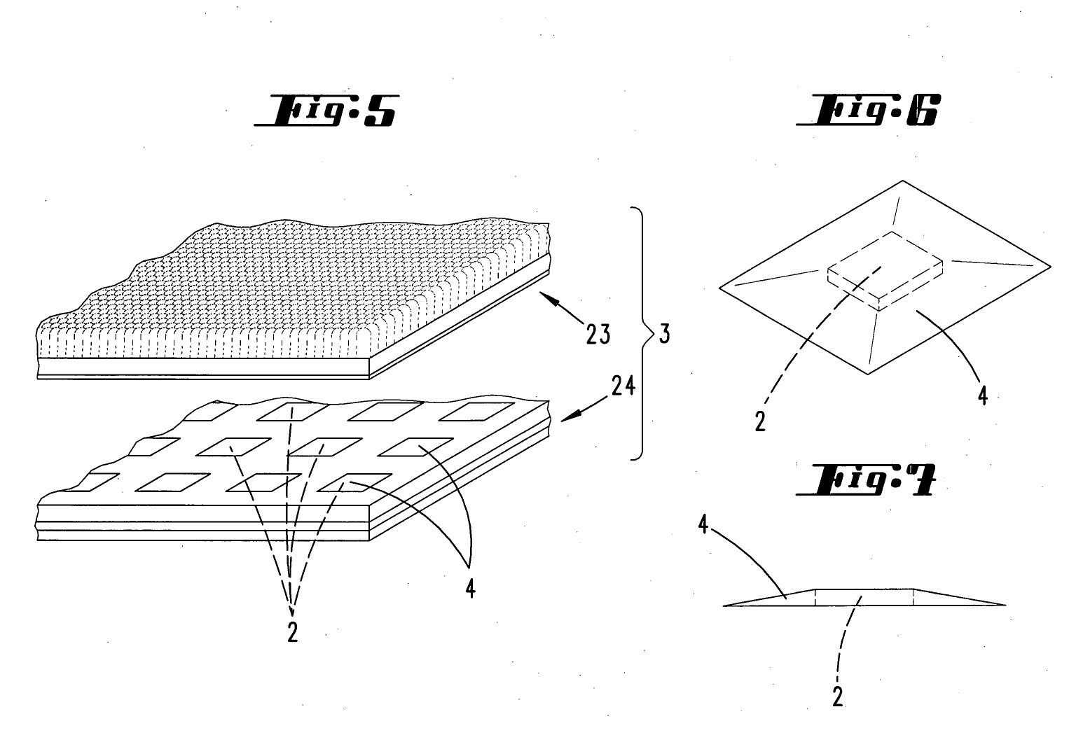

FIG. 6 shows, in perspective detailed illustration, an individual carrier comprising electronic components;

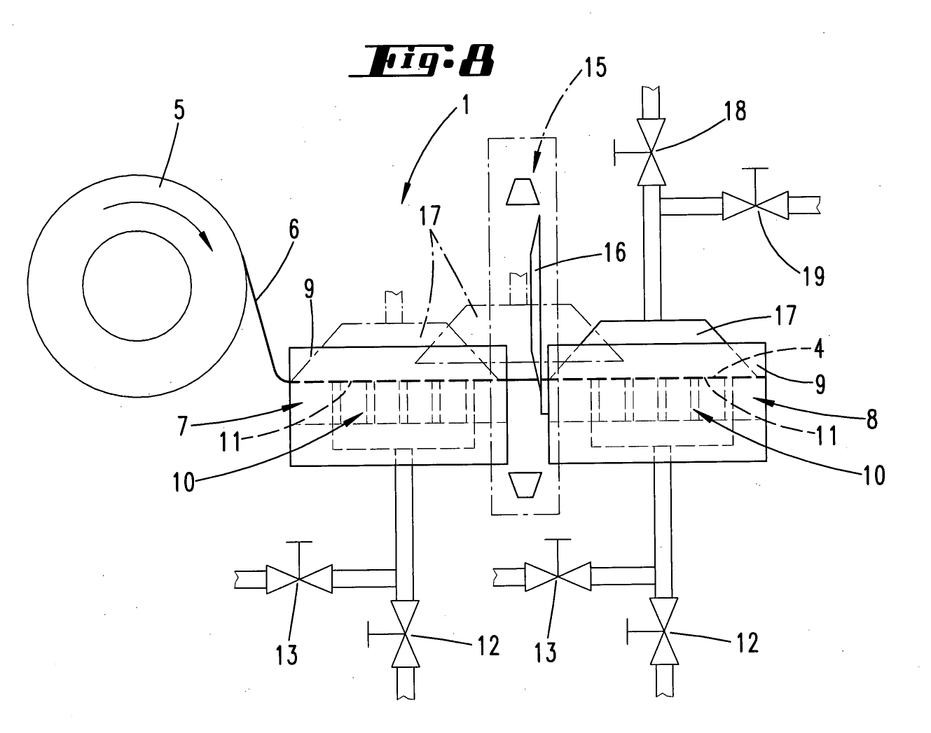

FIG. 7 shows, in exaggerated illustration, a side view of the foregoing;

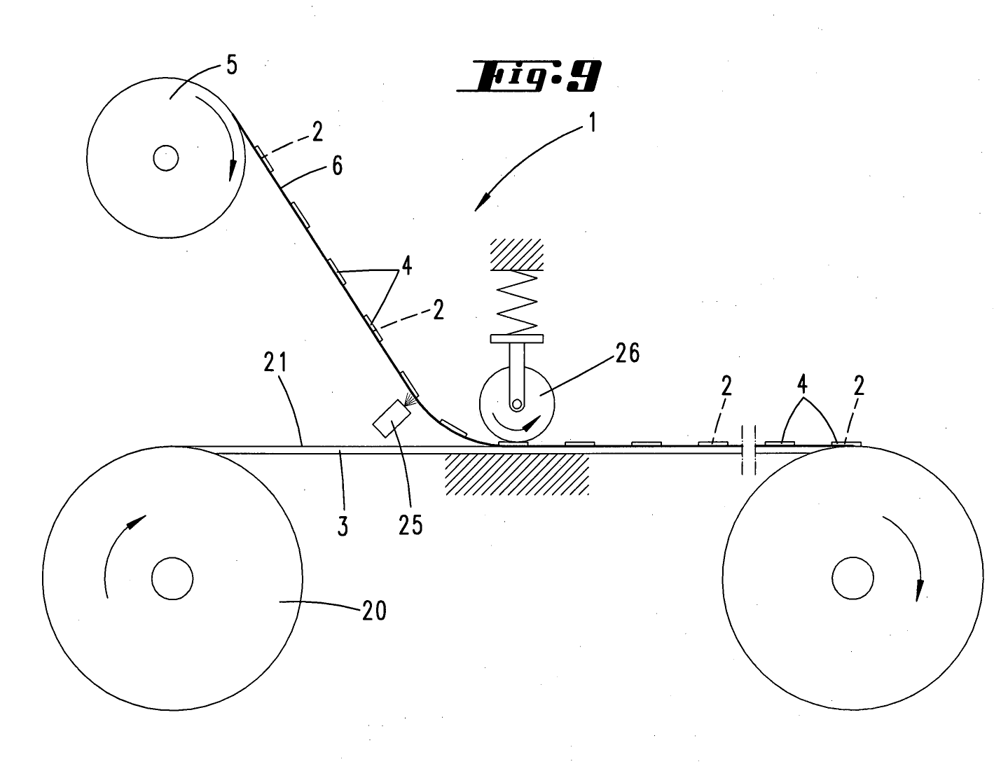

FIG. 8 is an illustration corresponding to FIG. 1, but for a second embodiment, and

FIG. 9 shows, in schematic illustration, the apparatus in a third embodiment.

Shown and described in first instance with reference to FIG. 1 is an apparatus 1 for application of electronic components 2 to a planar support, here a carpet 3.

The electronic components 2, thus for example RFIDs (transponders), tags and/or light emitting diodes, are connected fixedly to a component carrier 4 made of a plastics material forming the component carrier material and supplied on a continuous carrier roll 3.

As is to be seen in particular from the detailed illustrations in FIGS. 6 and 7, the electronic components 2 are enclosed in the component carrier 4, which is formed in a sleevelike manner or double-layered, and are thus protected against direct contact.

The carrier web 6 supplied on the roll 5 is guided over two support tables 7, 8 located one after the other in the direction r of transport. Both of the support tables have guide rails 9 extending on each side of the carrier web 6 on the table in the direction r of transport.

Both support tables 7 and 8 are provided with vacuum features 10, which act on the underside of the carrier web 6 on the table by way of the table surface 11. The valves for the vacuum action are provided with the reference numeral 12. Air supply valves carry the reference numeral 13.

Forward drive of the carrier web 6 is effected by way of an antistatic rubber roller 14, which interacts with the table surface 11 of the first support table 7 as seen in the direction r of transport. As is the case for this rubber roller 14, the further components of the apparatus coming into contact with the carrier web 6 and/or with the electronic components 2 are formed with an antistatic finish.

The rubber roller 14 delivers the free end of the carrier web 6 onto the table surface 11 of the second support table 8. In one of the standby positions to be detected, the carrier web is secured both in the region of the support table 7 and in the region of the support table 8 by means of the respective vacuum feature 10.

The detection unit is, in the exemplary embodiment illustrated, provided in the form of a light barrier 15. This is positioned between the support tables 7 and 8, viewed in the direction r of transport. Alternative detection units may be for example metal detectors or luminescence sensors.

The cutting position for the separation of the components or the component carrier 4 is likewise supplied by the detection. A cutting device 16 automatically separates the components 2 or the component carrier 4 at the detected position. A disk cutter is selected as cutting device in the exemplary embodiment illustrated. Separation is also conceivable by a shearing cut, laser or water jet.

After separation of the component carrier 4 has been carried out, the vacuum feature 10 of the second support table 8 carrying the separated component carrier 4 is switched off and the vacuum feature of a suction-cup-like handling device 17 is switched on. The vacuum valve for this is designated by 18. The associated air supply valve carries the reference numeral 19.

The surface of the handling device 17 which acts on the separated component carrier 4 corresponds in size with the table surface of the support table 8, as a result of which the separated component carrier 4 is taken over by the handling device 17 over its full area after the suction-cup-like vacuum has been switched on.

The handling device 17 can furthermore also be in the simplest manner a rubber sucker or also a grip.

Irrespective of the selected construction for the handling device 17, this device places the component carrier 4 equipped with the electronic component 2 onto the carpet 3 stored continuously on a roller 20, in particular on the facing carpet backing 21, which is stuck on by an adhesive adapted to the carrier web 6. This can be a hot-melt adhesive, dispersions or also flame lamination. In the exemplary embodiment illustrated, an adhesive spray device 22 is provided, which supplies adhesive to the portion to be coated in a cyclical manner. Accordingly, the adhesive is applied in a defined width and intensity immediately before the components 2 or component carrier 4 are placed on the carpet backing 21.

After the component carrier 4 has been applied to the carpet backing 21, the handling device 17 travels back again to the support table 8, into the initial position, after deactivation of its vacuum feature, in the course of which movement, the rubber roller 14 for the carrier web 6 has already advanced sufficiently far for the next carrier 4 to be separated to be already on the table surface 11 of the support table 8.

This process as described for separating and placing the component carriers 4 on the carpet backing 21 is repeated in accordance with the speed of the carrier and the speed of advance of the rubber roller 14 and the grid pattern to be produced.

For each row of components which is to be placed on the carpet backing 21, an individual apparatus 1 is provided, comprising its own continuous carrier roll 5. The apparatuses are synchronised, in order to ensure a uniform grid pattern across the entire width of the carpet 3.

As a further alternative, the electronic components 2 or the component carrier 4 comprising them may also be located between a first backing 23 and a second backing 24 of the carpet 3, thus for example initially on the surface of the second backing 24 which faces the first backing, following which the first and second backings are laminated in customary manner in order to give final form to the finished carpet 3. The electronic components are accordingly then covered over in a protected position, both on the upper side and on the lower side, by carpet or carpet backing material.

In a further embodiment, not illustrated, instead of the adhesive coating of the carpet backing as illustrated schematically in FIG. 4, the carrier web may also be provided with adhesive during the feed process, for example by way of a splash device, a spray device, or similar. For this, the support table 8 serves as an application location, the handling device 17 further serving in the course of the adhesive application as a fixing device. The transfer, which takes place after this, of the separated component carrier 4, which is coated with pressure-sensitive adhesive, is effected in the same manner as described with reference to the first exemplary embodiment.

As a further alternative, the carrier web 6 may also be provided with a self-adhesive layer, which is provided initially with a covering. This covering is removed before application of the component 2 or the separated component carrier 4, for which purpose a suitable pulling-off device in provided in the region of the support table 8.

An alternative in respect of the forward transport of the carrier web 6 is illustrated in FIG. 8 in a further embodiment. In this variant, the driven rubber roller 14 is left out. The transport of the carrier strip 6 is here effected rather by the handling device 17, which sucks up the free end of the continuous carrier web 6 on the support table 7, holds its and brings it to the support table 8 while drawing the carrier web 6 off from the continuous roll 5, and fixes it on table 8. After separation by cutting, the transfer of the component carrier 4 to the carpet 3 is effected, as described with reference to the first exemplary embodiment.

In FIG. 9, a further embodiment is illustrated, in which the electronic components 2 are not applied separately to the carpet backing 21, but rather as a “continuous” carrier strip, which is taken off directly from the continuous carrier roll 5 and, after application of a pressure sensitive adhesive by means of a spray device 25, is laminated directly to the carpet backing 21. The pressure roller acting on the carrier web 6 provided with the adhesive and the carpet backing 21 carries the reference numeral 26 and is located after the spray device 25 in the direction r of transport.

The electronic components 2 do not necessarily have to be disposed directly one after the other on the carrier web, in particular in the case of the embodiment according to the illustration in FIG. 9. Rather the arrangement may also be in a predetermined longitudinal grid. The separating and positioning can then be omitted. The components 2 are applied by means of a component carrier 4 which is continuous in the longitudinal direction of the carpet 1.

All features disclosed are (in themselves) pertinent to the invention. The disclosure content of the associated/accompanying priority documents (copy of the prior application) is hereby also included in full in the disclosure of the application, also for the purpose of incorporating features of these documents in claims of the present application.

1-29. (canceled)

30. Method for equipping a carpet (3), which has a front side and a rear side (21), with electronic components (2), wherein the electronic components (2), which are fixedly connected to a component carrier material forming a component carrier (4), are adhered to the carpet (3) by means of the component carrier (4) after they have been separated from a carrier web (6), the electronic components (2) being in a component carrier (4) formed to be double-layered, and, for the adhering, either adhesive previously applied to the carpet is used or the adhesive is applied to the carrier web immediately before placing of the components (2) on the carpet backing (21) or the component carrier has a self-adhesive layer.

31. Method according to claim 30, wherein the components (2) are adhered to the rear side (21) of the carpet (3).

32. Method according to claim 30, wherein the components (2) are located between a first backing (23) and a second backing (24) of the carpet (3) or the planar support (3).

33. Method according to claim 30, wherein the components (2) are separated before the adhering by suitable severing of the component carrier material, whereby the component carriers (4) are formed, and the components (2) are adhered in a prescribed grid pattern to the carpet (3) or the planar support (3).

34. Method according to claim 33, wherein the severing of the component carrier (4) is effected between two carrier holding stations.

35. Method according to claim 30, wherein holding of the component (2) on a carrier holding station is effected by vacuum.

36. Method according to claim 30, wherein a separated component (2) is applied to the carpet (3) or the planar support (3) by means of a movable holding part.

37. Method according to claim 30, wherein in the case of a self-adhesive layer, this layer is initially provided with a covering and the covering is removed before application of the component (2) or the component carrier (4) to the carpet (3) or the planar support (3).

38. Method according to claim 30, wherein the components (2) are pre-mounted on a continuous carrier roll (5).

39. Apparatus (1) for application of electronic components (2) to a planar support (3), for example floor covering, in particular in the form of a carpet, film or paper, the components (2) being pre-mounted, applied to a continuous carrier web (6), and a separation station being subsequently associated with the carrier web (6), in order to separate the components (2), wherein the separating station consists of two support tables (7, 8), which are located one after the other in the direction (r) of transport of the carrier web (6), and that a cutting station (16) is located between the support tables (7, 8), that a handling device (17) is associated with the further support table (8), and that the handling device (17) transports the separated component (2) or its component carrier (4) from the further support table (8) to the carpet (3) or the planar support (3) by means of vacuum.

40. Apparatus according to claim 39, wherein one support table (7, 8) has a drive roller (14).

41. Apparatus according to claim 39, wherein one support table (7, 8) has a vacuum device (10).

42. Apparatus according to claim 39, wherein the handling device (17) transports the component (2) onto a rear side of the carpet (3) or the planar support (3).

43. Apparatus according to claim 39, wherein application of adhesive to the component carrier (4) is effected on the further support table (8) in the course of advancing transport of the carrier (4).

44. Apparatus according to claim 39, wherein the component carrier (4) has a self-adhesive layer with a film covering, and that the film covering is removed in the region of the further support table (8).

45. Planar support (3), for example floor covering, in particular a carpet, film or paper, having a front side and a rear side and equipped with electronic components (2), the components being stuck onto the rear side of the planar support (3) by means of a component carrier (4), wherein the support has a first backing and a second backing, and that the components are located between the first backing and the second backing.

46. Support according to claim 45, wherein the components (2) are applied in a grid pattern having a regular longitudinal and transverse spacing.

47. Support according to claim 45, wherein the components (2) are applied by means of a component carrier (4) which is continuous in the longitudinal direction of the carpet (3).
